(19) United States
(12) Patent Application Publication
(10) Pub. No.: US 2007/0268681 A1
(43) Pub. Date: Nov. 22, 2007

(54) LUMINOUS KEYBOARD AND LIGHT MODULE THEREOF

(75) Inventors: Lei-Lung Tsai, Taipei County (TW); Wen-Yu Tsai, Changhua County (TW)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/750,313

(22) Filed: May 17, 2007

(30) Foreign Application Priority Data
May 19, 2006 (TW) TW95208626

(51) Int. Cl. F21V 33/00; G05D 25/00; F21V 8/00

(52) U.S. Cl. 362/85; 362/552; 362/582

(57) ABSTRACT

A luminous keyboard includes a circuit board, an elastic layer and a light module. The elastic layer on the circuit board includes a plurality of elastic portions. The light module includes a light guiding element and a light source. The light source is installed on the circuit board. The light guiding element covers the light source and includes an anti-dazzle portion and a light penetrating portion. The anti-dazzle portion blocks some light from the light source. The other light passes through the light penetrating portion illuminating the key.

### BACKGROUND OF THE INVENTION

1. Field of the Invention

The invention relates to a luminous keyboard and a light module thereof, and more particularly to a luminous keyboard and a light module thereof providing light from a light source to illuminate one point.

2. Description of the Related Art

Please refer to FIGS. 1 and 2, a conventional luminous keyboard 10 comprises a base 11, a front housing 16, and a plurality of keys 12, a circuit board 14 and an elastic layer 15. The circuit board 14 is disposed on the base 11. The front housing 16 is connected to the base 11. A light source 13, usually a light emitting diode, is disposed on the circuit board 14. The elastic layer 15 on the circuit board 14 comprises a plurality of elastic portions 151. The keys 12 are installed on the elastic portions 151. When the keys 12 are pressed downward, the elastic portion 151 of the elastic layer 15 provides a restoring force causing the key 12 to spring upward. Moreover, each key 12 has a hole 123 corresponding to the light source 13, allowing, light passing through the hole 123 to illuminate the keyboard 10 indicating if the function of the key 12 in a pressed or non-pressed state. A conventional keyboard 10 is not designed for collecting light, however, and a distance between the light source 13 and a key 12 scatters the light, obscuring the state of the key.

### BRIEF SUMMARY OF INVENTION

A detailed description is given in the following embodiments with reference to the accompanying drawings. The invention provides a luminous keyboard and a light module thereof. The light module is applied to a keyboard and installed in a key of the keyboard. The light module comprises a light source and a light guiding element. The light guiding element covers the light source and comprises an anti-dazzle portion and a light penetrating portion. The anti-dazzle portion prevents some light radiated by the light source from scattering, thus, only light passing through the light penetrating portion illuminates the key of the keyboardlight penetrating.

The light guiding element is made of a rubber.

The light guiding element is made of foam.

The light guiding element is made of a heat shrink tubing.

The light guiding element is made of an aluminum foil.

The light guiding element is made of a polyester film.

The luminous keyboard comprises a circuit board and an elastic layer. The circuit comprises a light source and the elastic layer is installed on the circuit board. The elastic layer comprises a plurality of elastic portions and a plurality of light guiding elements. Each light guiding element covers the light source and comprises an anti-dazzle portion and a light penetrating portion. The anti-dazzle portion blocks some light radiated by the light source, thus, only light passing through the light penetrating portion illuminates the key of the keyboard.

### BRIEF DESCRIPTION OF DRAWINGS

The invention can be more fully understood by reading the subsequent detailed description and examples with references made to the accompanying drawings, wherein:

FIG. 1 is a schematic view of a conventional keyboard;

FIG. 2 is an exploded view of a conventional keyboard;

FIG. 3 is an exploded view of a keyboard of the invention;

FIG. 4 is a schematic view of a light guiding element;

FIG. 5 is a schematic view of another embodiment of a light guiding element;

FIG. 6 is a schematic view of another embodiment of a light guiding element; and

FIGS. 7 is a schematic view of another embodiment of a light guiding element.

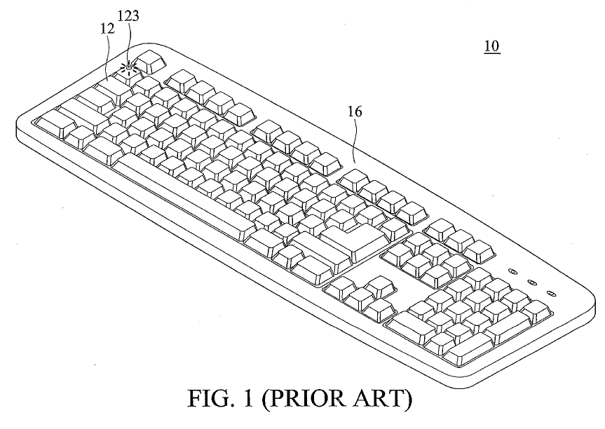

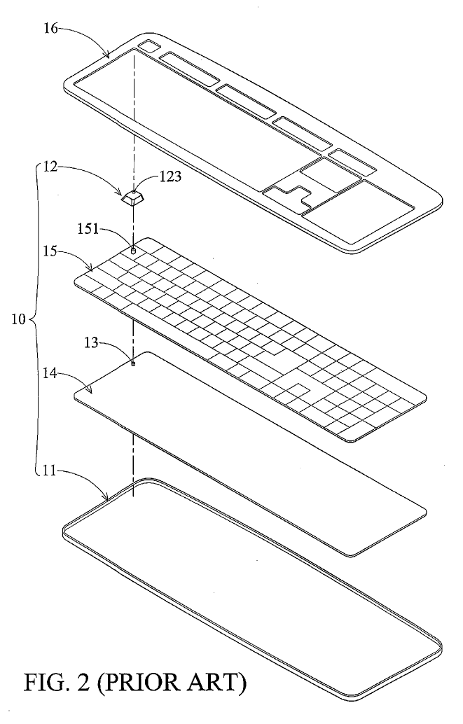

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

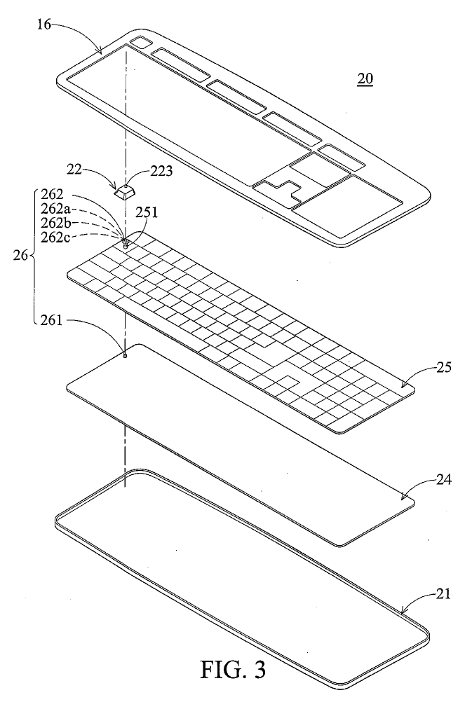

Referring to FIG. 3, a keyboard 20 of the invention comprises a front housing 16, a base 21, a circuit board 24, an elastic layer 25, a plurality of keys 22 and a light module 26. The circuit board 24 is disposed on the base 21 and the elastic layer 25 is disposed on the circuit board 24. The front housing 16 is connected to the base 21. The elastic layer 25 comprises a plurality of elastic portions 251. When the keys 22 above the elastic layer 25 are pressed downward, the elastic portion 251 of the elastic layer 25 provides a restoring force causing the key 22 to spring upward. The light module 26 comprises a light source 261 disposed on the circuit board 24 and a light guiding element 262 disposed on the elastic layer25. Note that the light source 261 is disposed under the key 22. Each key 22 comprises a light penetrating portion 223 corresponding to the light source 261 and the light guiding element 262. Light radiated from the light source 261 passes through the light penetrating portion 223 to illuminate the keyboard 20 indicating the state of a key 22.

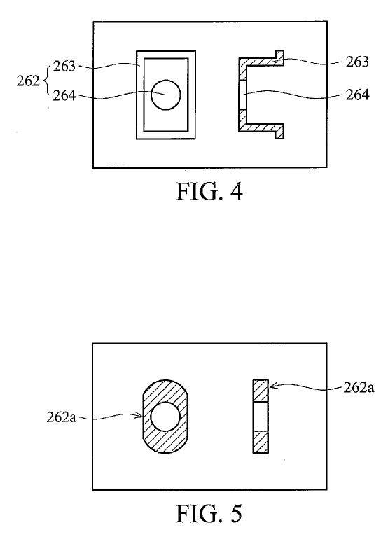

Referring to FIGS. 3 and 4, the light guiding element 262 further comprises an anti-dazzle portion 263. The anti-dazzle portion 263 blocks some light from the light source 261. The other light is not blocked by the anti-dazzle portion 263 and thus passes through the light penetrating portion 223 to illuminate the key 22. Because each key 22 comprises a hole 223, it can be observed whether the hole 223 is lit or not indicating the state of a key 22. The light guiding element 262 comprises a hollow protrusion. The light penetrating portion 262 comprises a hole. The light guiding element 262 is made of a rubber.

The light guiding element 262 of the invention is installed between the key 22 and the light source 261. Light from the light source 261 is collected, thus, only light passing through the light penetrating portion 223 illuminates the key 22 of the keyboard 20. Thus, the scattering problem of a conventional keyboard is avoided, further, the illumination efficiency of the keyboard is improved.

FIGS. 3 and 5 show another embodiment of the keyboard 20. The light guiding element 262a is made of foam or an aluminum foil. In this embodiment, the foam and the aluminum foil is adhered near the light source 261 for collecting light.

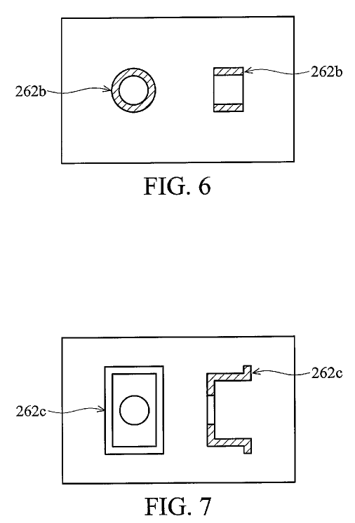

FIGS. 3 and 6 show another embodiment of the keyboard 20. The light guiding element 262b is made of a heat shrink tubing. After heating, the heat shrink tubing shrinks to wrap the light source 261 for collecting light.

FIGS. 3 and 7 show another embodiment of the keyboard 20. The light guiding element 262c is made of a polyester film. The polyester film is punched to wrap the light source 261 for collecting light. Thus, light is collected to illuminate the hole 223 of the key 22.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light module, disposed in a key of a keyboard, comprising:
a light source; and
a light guiding element, covering the light source and comprising an anti-dazzle portion and a light penetrating portion; wherein the anti-dazzle portion blocks some light from the light source; and the other light passes through the light penetrating portion illuminating the key.

2. The light module as claimed in claim 1, wherein the light penetrating portion comprises a hole.

3. The light module as claimed in claim 1, wherein the light guiding element comprises a hollow protrusion.

4. The light module as claimed in claim 1, wherein the light guiding element is made of a rubber.

5. The light module as claimed in claim 1, wherein the light guiding element is made of foam.

6. The light module as claimed in claim 1, wherein the light guiding element is made of a heat shrink tubing.

7. The light module as claimed in claim 1, wherein the light guiding element is made of an aluminum foil.

8. The light module as claimed in claim 1, wherein the light guiding element is made of a polyester film.

9. A luminous keyboard, comprising:
a key;
a light source, disposed under the key; and
a light guiding element, covering the light source and comprising an anti-dazzle portion and a light penetrating portion; wherein the anti-dazzle portion blocks some light from the light source; and the other light passes through the light penetrating portion illuminating the key.

10. The luminous keyboard as claimed in claim 9, wherein the light penetrating portion comprises a hole.

11. The luminous keyboard as claimed in claim 9, wherein the light guiding element comprises a hollow protrusion.

12. The luminous keyboard as claimed in claim 9, wherein the light guiding element is made of a rubber.

13. The luminous keyboard as claimed in claim 9, wherein the light guiding element is made of foam.

14. The luminous keyboard as claimed in claim 9, wherein the light guiding element is made of a heat shrink tubing.

15. The luminous keyboard as claimed in claim 9, wherein the light guiding element is made of an aluminum foil.

16. The luminous keyboard as claimed in claim 9, wherein the light guiding element is made of a polyester film.

17. The luminous keyboard as claimed in claim 9, further comprising a circuit board, the light source is disposed on the circuit board.
